(19) United States
(12) Patent Application Publication
(10) Pub. No.: US 2012/0170074 A1
(43) Pub. Date: Jul. 5, 2012

(54) METHOD OF AUTOMATIC SELECTIVE HANDLING OF SYNDICATED ITEMS

(76) Inventor: ERIK ACKERMAN, Lexington, KY (US)

(21) Appl. No.: 12/982,969

(22) Filed: Dec. 31, 2010

(51) Int. Cl. G06F 3/12

(52) U.S. Cl. 358/1.15

(57) ABSTRACT

A method of automatic selective handling of a syndicated item on a printing device linked to a syndication server that includes receiving a syndication feed from the syndication server and performing a syndicated item processing method based upon a first rule set in the printing device. The syndication feed includes a syndicated item, and the syndicated item has a first syndicated item property readable by the printing device.

### CROSS REFERENCES TO RELATED APPLICATIONS

This patent application is related to U.S. patent application Ser. No. 12/346,031, filed Dec. 30, 2008, entitled “Method of Updating a Printing Device via Syndication Services” and to U.S. patent application Ser. No. 12/346,238, filed Dec. 30, 2008, entitled “System For And Method Of Transmitting Device Status Information Via Syndication Services.” Both related patent applications are assigned to the assignee of the present application.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Technical Field

The present disclosure relates to a method of automatically processing syndicated items. Specifically, it relates to receiving syndication feeds containing syndicated items from the syndication server and processing the syndicated items based on rules set in the device.

2. Description of the Related Art

The setting of the present disclosure is a network (wired, wireless, or both) of devices such as printers, scanners, fax machines, multifunction printing devices, user computer devices, and handheld user computer devices. User computer devices connected to the network need the ability to intelligently and automatically process syndicated items that are received by the user computer devices through a syndicated feed from a syndication server. Traditionally, these syndicated items are processed by the user computer devices using one processing method for all the items, typically describing an all-or-nothing relationship. All syndicated items in the syndication feed are either processed using a single processing method or not.

Automatic selective handling is a beneficial component that will greatly benefit any organization. It will increase productivity since there is no longer a need to manually sort through the syndicated items received in the feed and assign a processing method to the items, which may or may not be appropriate for the syndicated items. Syndication feeds may include items that vary in type and nature and need to be processed differently from all other items in the feed. Thus, there is a need to process syndicated items automatically and intelligently, with each processing method customized for a particular syndicated item based on properties that are either inherent to the item or properties that are part of the syndication feed.

### SUMMARY

The present disclosure provides a method for automatic selective handling of syndicated items.

It is a first aspect of the present disclosure to provide a method of automatic selective handling of a syndicated item on a printing device linked to a syndication server that comprises receiving a syndication feed from the syndication server, the syndication feed including a syndicated item, and the syndicated item having a first syndicated item property readable by the printing device; and performing a syndicated item processing method based upon a first rule set in the printing device.

In a more detailed embodiment of the first aspect, the first rule associates the first syndicated item property with the syndicated item processing method. Further, the syndicated item processing method is performed when the syndicated item contains the first syndicated item property. In some embodiments of this aspect, the syndicated item further includes a second syndicated item property added prior to the receiving the syndication feed from the syndication server.

In another embodiment of the first aspect, the method of automatic selective handling of syndicated items on a printing device linked to a syndication server further comprises updating the first rule set in the printing device. In yet another embodiment, the method further includes receiving a second rule from a user. In some embodiments, the syndicated item processing method performs at least one of printing a document, installing an application, sending a fax message, sending an e-mail, updating a firmware. In yet other embodiments, the syndicated item processing method is executed on a predefined schedule.

It is a second aspect of the present disclosure to provide a method of automatic selective handling of syndicated items on a printing device linked to a syndication server that comprises receiving a syndication feed from the syndication server, the syndication feed including a syndicated item, and the syndicated item including a first syndicated item property; associating the first syndicated item property with a syndicated item processing method; and performing the syndicated item processing method when the syndicated item contains the first syndicated item property.

In a detailed embodiment of the second aspect, the method further comprises receiving a second syndicated item with a second syndicated item property prior to receiving to the syndication feed from the syndication server and associating the second syndicated item property with the syndicated item processing method. In some embodiments, the syndicated item processing method is executed on a predefined schedule. In a more detailed embodiment, the syndicated item processing method may be initiated by a user.

In yet another detailed embodiment of the third aspect, the syndicated item processing method is at least one of printing a document, installing an application, sending a fax message, sending an e-mail, and updating a firmware. In some embodiments, the method further comprises subscribing to the syndication feeds published by the syndication server.

It is a third aspect of the present disclosure to provide a printing device that is linked to syndication server. The printing device comprises a communication link that links the printing device and the syndication server, a memory, a user interface and a processor.

The processor is configured to receive a syndication feed from the syndication server, the syndication feed includes a syndicated item, and the syndicated item includes a first syndicated item property readable by the processor. The processor is also configured to associate the first syndicated item property with a first syndicated item processing method and perform the first syndicated item processing method when the syndicated item contains the first syndicated item property.

In some embodiments, the syndicated item further includes a second syndicated item property. The printing device is also configured to associate the second syndicated item property with a second syndicated item processing method.

In a more detailed embodiment, the printing device is further configured to perform the first syndicated item processing method on a predefined schedule. In a yet more detailed embodiment, the printing device receives a syndication feed from a syndication server if an update is available from the syndication server.

From the foregoing disclosure and the following detailed description of various example embodiments, it will be apparent to those skilled in the art that the present disclosure provides a significant advance in the art of methods of handling syndicated items. Additional features and advantages of various example embodiments will be better understood in view of the detailed description provided below.

### BRIEF DESCRIPTION OF THE DRAWINGS

The above-mentioned and other features and advantages of the present to disclosure, and the manner of attaining them, will become more apparent and will be better understood by reference to the following description of embodiments o taken in conjunction with the accompanying drawings, wherein:

FIG. 1 is a flow diagram of one example embodiment;

FIG. 2 is a flow diagram of a second example embodiment;

FIG. 3 is a view of an example hardware and software environment utilized in one example embodiment;

FIG. 4 is a view of an example hardware and software environment utilized in one example embodiment;

FIG. 5 is a view of an example hardware and software environment utilized in one example embodiment; and

FIG. 6 is a block diagram of one aspect of a system utilized in one example embodiment.

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “linked” and variations thereof are used herein broadly and encompass direct and indirect connections, couplings, and mountings. In addition, the terms “connected”, “coupled”, and “linked” and variations thereof are not restricted to physical or mechanical connections or couplings.

### DETAILED DESCRIPTION OF THE DRAWINGS

It will be apparent to those skilled in the art that many uses and variations are possible for the methods of automatic selective handling of syndicated items. The following detailed discussion of various alternative and example embodiments will illustrate the general principles of the invention. Other embodiments will be apparent to those skilled in the art given the benefit of this disclosure.

The present disclosure generally relates to a method of automatic selective to handling of syndicated items that are received by a printing device from a syndication server.

Some examples of printing devices include printers, scanners, fax machines, multifunction devices, and other printing devices. Some examples of user computer devices include computer servers, personal computers, desktop computers, laptop computers, handheld computers, personal digital assistants, cellular telephones, and other user computer device. Various embodiments may utilize a plurality of printing devices and/or a plurality of syndication servers. Some embodiments may also utilize a plurality of user computer devices

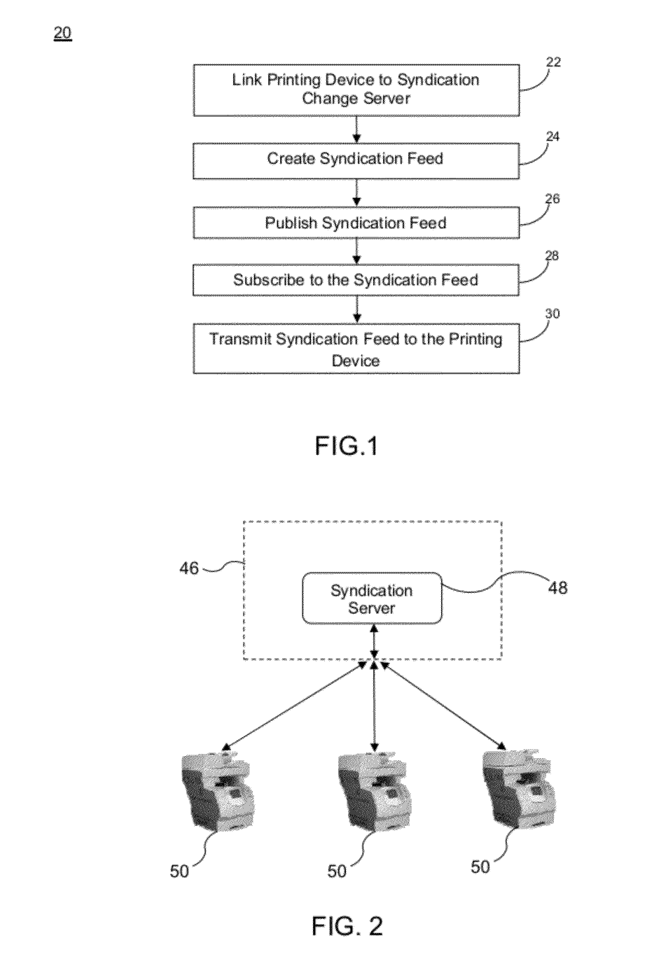

FIG. 1 depicts a flow diagram of one example embodiment, which may operate on a system as shown in FIG. 2. In this aspect, a computer implemented method of automatic selective handling of syndicated items is provided and is generally designated 20. This method first teaches linking a printing device 50 (block 22) via one or more data links to a syndication server 48 (shown in FIG. 2). The printing device 50 may be capable of performing a variety of operations including, without limitation, printing documents, storing files, sending faxes, sending e-mail, copying, updating firmware, installing applications, querying the syndication server 48 for updates, receiving syndication feeds from the syndication server 48 and processing the syndicated items included in the syndication feeds based on the properties of the syndicated items or the syndicated feeds. The syndication feeds may be or may include computer-readable files complying with a syndication protocol. At block 24, a syndication feed may be created on the syndication server 48 via the user computer device 46. The syndication feed may be published (block 26), allowing the printing device 50 to subscribe to the syndication feed. The printing device 50 may then subscribe to the syndication feed at block 28. It will be appreciated by one or ordinary skill in the art that the printing device 50 may subscribe to one or more syndication servers 48 and/or one or more syndication feeds. At block 30, the syndicated feed may be transmitted from the syndication server 48 to the printing device 50.

The syndicated feeds may be or may include one or more syndicated items in the form of attachments. The syndicated items or the entire syndicated feed may be processed in the printing device 50 based on rules set in the device which will be described in detail below. This processing enables the printing device 50 to process the syndicated items, which may include, without limitations, printing documents, storing files, sending faxes, sending e-mail, copying, updating firmware and installing applications.

Syndicated items may include computer-readable files such as documents, to applications, update information, firmware and other files that may or may not be associated with the at least one printing device 50 and may be capable of being transmitted from the syndication server 48 to the printing device 50.

The properties of the syndicated items may include, but are not limited to title, filename and file extension. Properties of the syndication feed may include, without limitation, description, author, category, publication date, genre and attachment MIME type. It will be appreciated by one of ordinary skill in the art that the syndication feed and the syndicated items may have more properties than those above-mentioned and that any number of properties of the syndication feed may be added by whoever is generating the syndication feed. Any number of properties for the syndicated items may also be added by the creator of the syndicated items or the computer-readable files. Properties may be added to one of the syndicated items or the syndicated feed prior to the transmission of the syndicated feeds from the syndication server 48 to the printing device 50. One of ordinary skill in the art will also recognize that properties of the syndicated items and syndication feed may include features and attributes that are inherent to the syndicated items and syndication feeds, or features and attributes that may be added to the items and feeds during or after creating the items and generating the feeds.

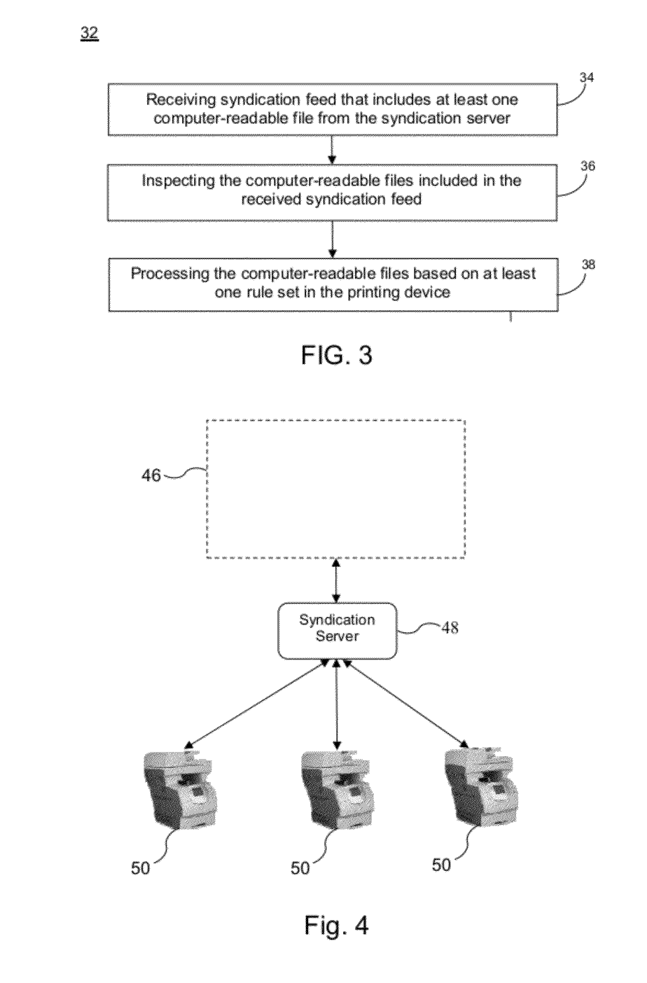

FIG. 3 depicts a flow diagram of a second embodiment, generally designated 32. This example embodiment first teaches receiving, by a printing device 50, syndication feeds that include at least one computer-readable file or syndicated item from the syndication server 48 (block 34). At block 36, the properties of the syndicated items or the syndication feeds received may be inspected by the printing device 50. The properties of the syndicated items may include, but are not limited to, title, filename and file extension. Properties of the syndication feed may include, without limitation, description, author, category, publication date, genre and attachment MIME type. It will be appreciated by one of ordinary skill in the art that the syndication feed and the syndicated items may have more properties than those above-mentioned and that any number of properties of the syndication feed may be added by whoever is generating the feed, and that any number of properties of the syndicated items may be added by the creator of the syndicated items or the computer-readable files. Properties may be added to one of the syndicated items or the syndicated feed prior to the transmission of the syndicated feeds from the syndication server 48 to the printing device 50. At block 44, the syndicated items may be processed using at least one processing method to based on rules set in the printing device 50.

The syndication feeds may be or may include syndicated items that are computer-readable files that may be transmitted from the syndication server 48 to at least one printing device 50 via one or more data links. The syndication server 48 may be connected to the printing device 50 in different types of hardware and software environments, such as those shown in FIGS. 2, 4, 5 and 6. The syndicated items may be in any format recognized by printing device 50 and capable of being transmitted by syndication server 48. The syndicated items and the syndication feeds may include properties that are readable by the printing device 50.

The processing of the computer-readable files or the syndicated items by the printing device 50 may include, without limitation, installing an application, sending faxes, sending e-mails, printing, updating firmware and other processing methods which the printing device 50 is capable of performing. One of ordinary skill in the art would recognize that the printing device 50 may have an extensible list of processing methods that it is capable of performing which are not limited to those aforementioned.

The rules set in the printing device 50 may determine the type of processing method that will be used to process the syndicated items. The rules may associate properties of the syndicated items and/or the syndicated feeds with a particular type of processing method that the printing device 50 is capable of performing. The rules may be stored in on-board storage of the printing device 50 and referred to in the processing of the particular syndicated items or computer readable files, or in the processing of the whole syndication feed. For example, a rule may be set in the printing device 50 that associates the file extension, “.pdf”, to a processing method of printing. Thus, when the printing device 50 receives a syndicated item with a file extension of “.pdf”, it may print the file automatically or on a predefined schedule. Another example of a rule set in the printing device 50 is one that saves in the server syndication feeds that contain the word “save” anywhere in the title. Thus, when the printing device 50 receives a syndication feed with the word “save” in its title, it may automatically save the syndicated items in the syndication feed to the server, either upon receipt of the syndication feed or on a predefined schedule.

In other embodiments, additional functions, features or elements may be added to the method as depicted in FIG. 3. These functions may include setting additional rules in the printing device 50. Users may create new rules based on their individual needs to automatically and selectively handle particular syndicated items that are received by the to printing device 50 from the syndication server 48. Properties of syndicated items and syndication feeds may be modified for a particular type of user prior to the transmission of the syndication feeds from the syndication server 48 to the printing device 50. These properties are customizable, and new rules may be set in the printing device 50 that will handle syndicated items and syndication feeds with newly-set properties. For example, a syndicated item may be a text document with a title bearing the word “Important.” A new rule may be added that associates syndicated items with titles having the word “Important” with both printing the syndicated items and saving them to the syndication server.

In another example embodiment, some rules may be set as defaults. For example, when the printing device 50 receives a syndicated item or syndication feed that contains a particular property, a specific processing method may be applied to it every time.

In yet another example embodiment, the rules may be updated or modified. For example, an existing rule set in the printing device 50 that associates the property of a syndicated item's description containing the word “Save” with the processing method of printing may be modified to update the processing method from printing to printing the syndicated item and storing it in the server. The ability to update, modify or create additional rules would be useful in customizing the rules based on people's changing needs or changing trends in handling particular computer-readable files. For example, an important file that is sent for printing which may be printed at a later time by another person may be saved in the server so that repeated sending of print jobs to the printing device 50 for printing may be eliminated. In this manner, files that need to be printed by multiple users may be saved and accessed in the printing device 50, eliminating the need to access electronic mails or shared network drives in order to print the files that have been printed by others.

In other embodiments, the rules set in the printing device may also be deleted. For example, there may be existing rules that are no longer relevant to the organization. One such rule may be saving to the server syndicated items with the word “Save” in their title. If the users of the printing device 50 no longer need to save syndicated items in their server, they may choose to delete the rules that save syndicated items in the server. In this manner, users can free up memory of their printing device 50 for other operations or rules by deleting rules that are no longer used or needed.

Rules may be saved in the on-board storage media of the printing device 50. People of ordinary skill in the art will recognize that there are a variety of ways to store the to rules in the printing device, such as in flash RAM or NVRAM or the hard disk. Rules may also be stored on a remote server or in any location or storage media that is accessible by the printing device 50.

In yet other embodiments, the processing of the syndicated items or syndicated feeds based on the rules set in the printing device 50 may be performed automatically when the printing device 50 receives the syndication feeds from the syndication server 48. For example, when the printing device 50 receives a syndicated item from the syndication sever 48 with a property that is associated to an update firmware processing method, the printing device 50 automatically updates firmware. In this manner, the need to manually update the firmware of the printer is eliminated.

In still other embodiments, the processing of the syndicated items or syndicated feeds based on the rules set in the printing device 50 may be performed based on a predefined schedule. The predefined schedule may be set at any time interval, such as hourly, daily or monthly, and may be set as a setting in the printing device 50 or in the rules that are set in the printing device 50. For example, the printing device 50 may print the documents that are to be printed at a particular time of the day. In this manner, the processing is more predictable and users of the printing device 50 would more precisely know when to retrieve the printed documents from the printing device 50.

Data links linking various components of the embodiments of the present disclosure may be any known data links. For example, the data link linking the printing device 50 to the syndication server 48 may be wired or wireless. A wired data link may include integrated circuitry within the printing device 50, a USB data link, Firewire data link, or other similar data link. A wireless data link may include a Wi-Fi data link, WiMax data link, wireless USB data link, Bluetooth data link, or other similar data link. In another example, the data link linking the user computer device 46 to the syndication server 48 may be a wireless data link while the data link linking the user computer device 46 to the printing device 50 may be wired.

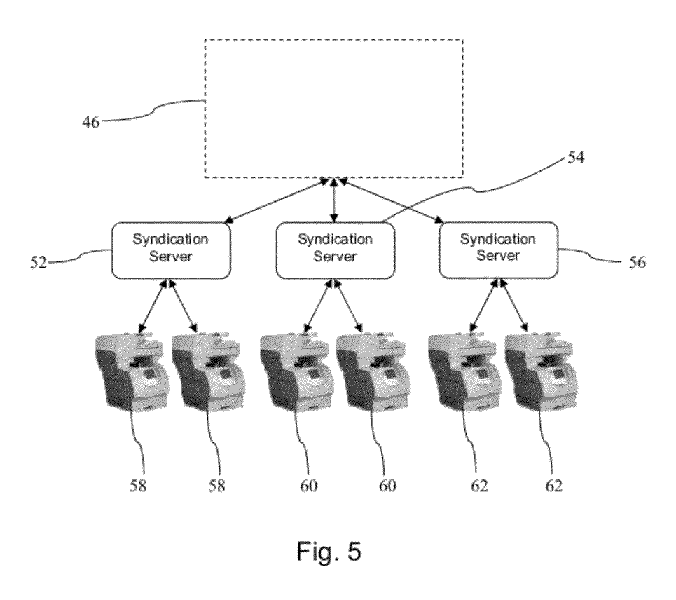

The syndication server 48 may be incorporated within the printing device 50 by software application or firmware integration. In other embodiments, the syndication server may be located external to the printing device 50, as shown in FIGS. 4 and 5, for example. In yet other embodiments, the syndication server 48 may be located on a user computer device 46 administered by the manufacturer of the printing device 50. Functions of the syndication server 48 may include, but are not limited to, notifying printing devices 50 that subscribe to its feeds when new syndication feeds are available, receiving syndicated feeds or computer readable files, and transmitting the syndicated feeds or computer readable files.

The printing device 50 receiving the syndication feeds from the syndication server 48 may be performed when a new update is available in the syndication server 48. For example, when a syndication server 48 broadcasts an update and notifies the printing device 50 that a syndication feed is available for transmission, the printing device 50 may then receive the syndication feed. Alternately, the transmission and receiving of syndication feeds from the syndication server 48 to the printing device 50 may be done on a predefined schedule. For example, transmission of the syndicated feeds may be done any time interval, such as daily, weekly, or monthly.

The syndication server 48 may be a software application, a software application extension, or a web-based utility. The syndication server 48 may operate on the user computer device 46 or other device. Additionally, the syndication server 48 may be implemented to display the syndication feeds in web-based portals, internet browser applications, e-mail applications, or blog editors. In an example embodiment, the syndication server 48 may implement the Really Simple Syndication syndication protocol, such as RSS 2.0. However, one or ordinary skill in the art would recognize that any other syndication protocol format may be utilized so long as the format is capable of supporting attachments.

In some embodiments, each printing device 50 has the software and associated circuitry for accessing syndicated feeds and syndicated items such as documents, applications, firmware, software and other computer-readable files. The capability of a printing device 50 to access syndication feeds may be a native capability of the printing device's 50 firmware. This capability may also be an add-on feature that is installed in the printing device 50 through the use of a software application.

In one example embodiment, printing devices 50 may be pre-configured by the manufacturer or retailer to access or subscribe to update information or a syndication feed located on a central server. For example, a printer manufactured by Lexmark International, Inc. and sold by a retailer may be pre-configured through firmware or software to access update information or a syndication feed located on servers owned and/or maintained by Lexmark International, Inc. Additionally, a retailer may also pre-configure these printing to devices 50 through firmware or software to access update information or a syndication feed located on servers owned and/or maintained the retailer.

FIGS. 2, 4 and 5 depict views of example hardware and software environments utilized in various embodiments of the present disclosure. FIG. 2 shows an environment in which the syndication server 48 is operating within the user computer device 46. FIG. 4 shows an environment in which the syndication server 48 is located between the user computer device 46 and the printing devices 50. FIG. 5 shows an environment in which multiple printing devices 58, 60, 62 communicate with multiple syndication servers 52, 54, 56. Each of these environments may be utilized in various embodiments of the present disclosure.

The environment shown in FIG. 3 may include a user computer device 46, a syndication server 48, and a plurality of printing devices 50. The user computer device 46 may include the syndication server 48 operating as a software application thereon. In this embodiment, one or more printing devices 50 may communicate with the syndication server 48 via the user computer device 46. The syndication server 48 in this embodiment may allow a user or administrator to create, publish, and/or place syndication feeds and include syndicated items or computer-readable files in the syndication feeds to be transmitted to the printing device 50. All transmission of syndication feeds and syndicated items to the printing devices 50 in this embodiment may occur by way of the user computer device 46.

The environment shown in FIG. 4 may include a user computer device 46, a syndication server 48, and a plurality of printing devices 50. In this example embodiment, the syndication server 48 may operate independently of the user computer device 46 and/or may operate on another device. In this example embodiment, one or more printing devices 50 may communicate with the syndication server 48 via the data links without a need to communicate using the user computer device 46. The syndication server 48 in this embodiment may also allow a user to create, publish, and/or place syndication feeds and syndicated items or computer readable files. All transmission of syndication feeds, which may include computer-readable files, to the printing device 50 in this embodiment may occur directly from the syndication server 48.

The environment shown in FIG. 5 includes a user computer device 46, a plurality of syndication servers 52, 54, 56, and a plurality of printing devices 58, 60, 62. Each syndication server 52, 54, 56 in this example embodiment operates independently of the to user computer device 46. The syndication servers 52, 54, 56 in this example embodiment may operate on separate devices or on the same device. One or more printing devices 58, 60, 62 may communicate with its respective syndication servers 52, 54, 56 via the data links without a need to communicate using the user computer device 46. The syndication servers 52, 54, 56 in this example embodiment may also allow a user or administrator to create, publish, and/or place syndication feeds with or without syndicated items. All transmission of syndication feeds that may or may not have syndicated items to the printing devices 58, 60, 62 in this example embodiment may occur directly from the syndication servers 52, 54, 56.

The example environment of FIG. 5 may operate as follows. Printing devices 58, 60 and 62 may be different types of printers with different model numbers, features and/or functions. For example, printing devices 58 may be monochrome laser printers not capable of scanning; printing devices 60 may be color laser printers capable of scanning but not capable of e-mailing; and printing devices 62 may be multi-function inkjet printers. Therefore, these printing devices 58, 60 and 62 may each utilize different rules to process different syndicated feeds and syndicated items. The administrator may set up syndication server 52 to include syndicated feeds that are meant to be processed by printing device 58.

The administrator may set up syndication server 54 to include syndicated feeds that are meant to be processed by printing device 60. The administrator may set up syndication server 56 to include syndicated feeds that are meant to be processed by printing device 62. If this example was enlarged such that there were 100 printing devices like printing devices 58, 100 printing devices like printing devices 60, and 100 printing devices like printing devices 62, it is easy to see the time, effort, and cost savings by implementing the example embodiment. Instead of setting up rules for 300 printing devices manually, the administrator may only need to update three syndication servers 52, 54 and 56. In other embodiments, there may be only one syndication server 26 that includes syndication feeds that may or may not have syndicated items or computer-readable files for a plurality of printer types or models.

While the above embodiments tend to focus on printing environments, other embodiments of the present disclosure may be implemented outside the scope of a printing environment. Other embodiments may include other devices and networks such as security systems and data collection. One example may be a computing device that subscribes to a syndication server and needs to selectively handle syndicated items received from the server based on the items' properties.

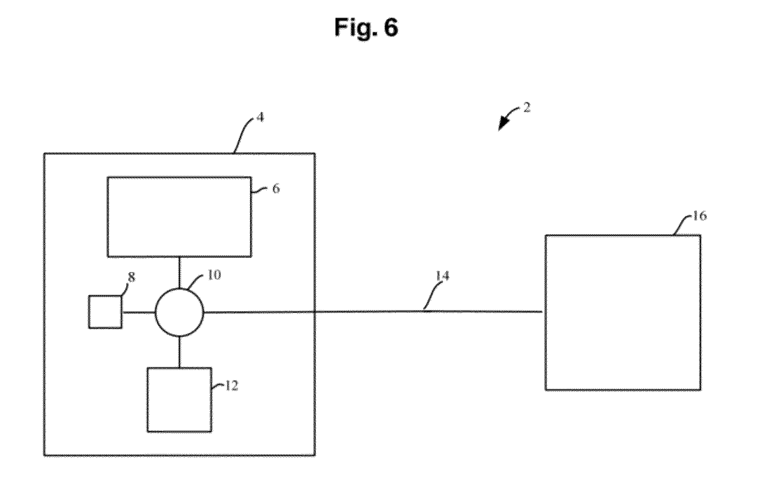

As shown in FIG. 6, one aspect of a system for automatic selective handling of to syndicated items, generally designated 2, may include a device 4, in communication with a syndicated server 16 via a network 14. The network 14 may be a public switched telephone network (PSTN), which may include a wireless or landline component, a local area network, a wide area network, the internet, the intranet or a combination thereof.

The device 4 may be a printer, a copier, a scanner, an all-in-one (AIO) device, an MFP or the like. In one aspect, the device 4 may include a processor 10 in communication with a user interface 6, a memory 8, and a scanning subsystem 12. The user interface 6 may be a graphical user interface, a monitor, a series of buttons, a touch-sensitive display panel, a voice-activated interface, a speaker or the like. In one aspect, the user interface 6 may serve as an operating panel for the device 4. It is also within the scope of this aspect to utilize a computer, such as personal computer, having a monitor as the user interface 4. Those skilled in the art will appreciate that the device 4 may include various additional components, such as a facsimile, a copier or a card reader.

The processor 10 in device 4 may be configured to receive syndication feeds from the syndication server 16, the syndication feeds including a syndicated item, and the syndicated item including a syndicated item property readable by the processor 10. The processor 10 may also be configured to associate the first syndicated item property with a first syndicated item processing method and to perform the syndicated item processing method when the syndicated item contains the syndicated item property.

Following from the above description, it should be apparent to persons of ordinary skill in the art that, while the methods and apparatuses herein described constitute example embodiments of the present disclosure, it is to be understood that the disclosures contained herein are not limited to the above precise embodiments and that changes may be made without departing from the scope of the disclosure as defined by the claims. Likewise, it is to be understood that the invention is defined by the claims, and it is not necessary to meet any or all of the identified advantages or objects of the invention disclosed herein in order to fall within the scope of the claims since inherent and/or unforeseen advantages of the present disclosure may exist even though they may not have been explicitly discussed herein.

What is claimed is:

1. A method of automatic selective handling of a syndicated item on a printing device linked to a syndication server, comprising:
receiving a syndication feed from the syndication server, the syndication feed including a syndicated item, and the syndicated item having a first syndicated item property readable by the printing device; and
performing a syndicated item processing method based upon a first rule set in the printing device.

2. The method of claim 1, wherein the first rule associates the first syndicated item property with the syndicated item processing method.

3. The method of claim 2, wherein the syndicated item processing method is performed when the syndicated item contains the first syndicated item property.

4. The method of claim 1, wherein the syndicated item further includes a second syndicated item property added prior to the receiving the syndication feed from the syndication server.

5. The method of claim 1, further comprising updating the first rule set in the printing device.

6. The method of claim 1, further comprising receiving a second rule from a user.

7. The method of claim 1, wherein the syndicated item processing method performs at least one of printing a document, installing an application, sending a fax message, sending an e-mail, and updating a firmware.

8. The method of claim 1, wherein the performing the syndicated item processing method is executed on a predefined schedule.

9. A method of automatic selective handling of a syndicated item on a printing device linked to a syndication server, comprising:
receiving a syndication feed from the syndication server, the syndication feed including a syndicated item, and the syndicated item having a first syndicated item property;
associating the first syndicated item property with a syndicated item processing method; and
performing the syndicated item processing method when the syndicated item contains the first syndicated item property.

10. The method of claim 9, further comprising receiving a second syndicated item with a second syndicated item property prior to the receiving the syndication feeds from the syndication server.

11. The method of claim 10, further comprising associating the second syndicated item property with the syndicated item processing method.

12. The method of claim 9, wherein the performing the syndicated item processing method is executed on a predefined schedule.

13. The method of claim 9, wherein the performing the syndicated item processing method may be initiated by a user.

14. The method of claim 9, wherein the syndicated item processing method is at least one of printing a document, installing an application, sending a fax message, sending an e-mail, and updating a firmware.

15. The method of claim 9, further comprising subscribing to the syndication feed published by the syndication server.

16. A printing device linked to a syndication server comprising:
a communication link between the printing device and the syndication server;
a memory;
a user interface; and
a processor, the processor configured to:
receive a syndication feed from the syndication server, the syndication feed including a syndicated item, and the syndicated item having a first syndicated item property readable by the processor;
associate the first syndicated item property with a first syndicated item processing method; and
perform the first syndicated item processing method when the syndicated item contains the first syndicated item property.

17. The printing device of claim 16, wherein the syndicated item further includes a second syndicated item property.

18. The printing device of claim 17, wherein the processor is further configured to associate the second syndicated item property with a second syndicated item processing method.

19. The printing device of claim 16, wherein the processor further configured to perform the first syndicated item processing method on a predefined schedule.

20. The printing device of claim 16, wherein the processor is further configured to receive the syndication feed from the syndication server if an update is available from the syndication server.
